(19) United States
(12) Patent Application Publication
(10) Pub. No.: US 2013/0033412 A1
(43) Pub. Date: Feb. 7, 2013

(54) ARRANGEMENT FOR WIRELESSLY NETWORKING DEVICES IN AUTOMATION TECHNOLOGY

(71) Applicant: Pilz GmbH & Co., KG, Ostfildern (DE)

(72) Inventors: Thorsten GODAU, OSTFILDERN (DE); Alois INEICHEN, RUSWIL (CH)

(73) Assignee: PILZ GMBH & CO. KG, OSTFILDERN (DE)

(21) Appl. No.: 13/649,306

(22) Filed: Oct. 11, 2012

Related U.S. Application Data
(63) Continuation of application No. PCT/EP2011/055774, filed on Apr. 13, 2011.

(30) Foreign Application Priority Data
Apr. 14, 2010 (DE) 10 2010 015 650.7

(51) Int. Cl. H01Q 1/50

(52) U.S. Cl. 343/852

(57) ABSTRACT

An arrangement for wirelessly networking sensors, actuators and at least one shared control unit in automation technology, has a first connection point for receiving an RF transmit signal from an RF transmitter and for providing an RF receive signal from an antenna. The arrangement has a second connection point, which leads to the antenna, and a signal coupler, arranged between the first connection point and the second connection point. The signal coupler transmits the RF transmit signal from the first connection point to the antenna, and transmits the RF receive signal from the antenna to the first connection point. The signal coupler has a variable coupling attenuation with a low first attenuation factor and at least one higher second attenuation factor. The signal coupler transmits the RF receive signal using the low first attenuation factor and transmits the RF transmit signal using the higher second attenuation factor.

### CROSS REFERENCES TO RELATED APPLICATIONS

This application is a continuation of international patent application PCT/EP2011/055774, filed on Apr. 13, 2011 designating the U.S., which international patent application has been published in German and claims priority from German patent application DE 10 2010 015 650.7, filed on Apr. 14, 2010. The entire contents of these prior applications are incorporated herein by reference.

### BACKGROUND OF THE INVENTION

The present invention relates to an arrangement for wirelessly networking or interconnecting devices used in automation technology, such as remote sensors, remote actuators and at least one control unit.

It has already been known for many years to arrange sensors and actuators for controlling an automated system remote from a control unit, which processes the sensor data from the sensors, and generates on the basis thereof actuator data that is used to control the actuators. Actuators are, for example, electrical drives, solenoid valves or contactors, which can be used to switch a load current on or off. Sensors detect system states or process states, for instance the rotational speed of an electrical drive, actuation of a pushbutton, the temperature of a substance or the opening position of a door. In many cases, the sensors and actuators are distributed in an automated system, whereas the control unit is arranged at a central point. There are also systems in which a plurality of control units are used, which likewise can be arranged in a distributed manner within the system.

Communication networks are nowadays used for transmitting the control data between the sensors, control units and actuators, thereby allowing flexible data communication. Today's communication networks are based on similar technologies to those also used for networking computers in home and office applications. However, there are technical differences resulting primarily from the fact that the sensor data and actuator data (control data) must usually be transmitted under very tight time tolerances in order to guarantee a rapid response by the control unit to changes in the controlled system or the controlled process. This is particularly true when transmitting and processing safety-relevant control data on which the health or even the life of a machine operator depends, such as switching off an electrical drive in response to actuation of an emergency stop pushbutton.

Particular difficulties arise when the sensors, actuators and control units are to be networked together wirelessly, because automated systems are often located in factory halls and/or in areas containing numerous metallic structures (including steel stands, steel racks, corrugated metal walls, metal grilles, cranes, machines). The metallic structures produce a multiplicity of undefined reflections of an electromagnetic transmit signal, with the result that the receiver receives the transmit signal several times at different points in time. This is known as “multipath propagation”, and is also known in other wireless communications networks, such as in mobile radio. In industrial environments containing numerous metallic structures, however, it is extreme and frequently results in breaks in communication and consequently unstable communications links.

One approach for improving the stability of communications links in environments having multipath propagation is for the receiver to use a plurality of antennas, wherein the plurality of antennas are arranged at different positions (what is known as “antenna diversity”). The receiver can switch between the different receive antennas and thereby respond to different reception conditions.

DE 10 2007 058 258 A1 proposes an arrangement having an antenna changeover switch, which selectively connects a signal path for transmitting a radio frequency signal to a first antenna or to a second antenna, wherein a low-frequency changeover signal for the antenna switch is generated from successive signal bursts of an RF transmit signal. Since communication between the sensors, actuators and control units of the automated system takes place cyclically within defined time intervals, the proposed antenna changeover switch automatically switches between the antennas in regular time intervals. The arrangement enables higher availability and reliability in the wireless networking of devices in automation technology at very reasonable cost.

DE 10 2007 058 257 A1 proposes an advantageous antenna design having two integral antennas, between which it is possible to switch using a suitable antenna changeover switch.

The proposed antenna design and antenna changeover switch have provided good results in various industrial environments, but there is still room for improvement, especially for use in factory halls containing numerous metallic structures and extremely strong multiple reflections resulting therefrom. Consequently, there is a desire to find additional approaches for establishing a stable, wireless communication link in factory halls and similar environments that have severe multipath propagation.

### SUMMARY OF THE INVENTION

Against this background, it is an object of the invention to provide an arrangement that enables an even more stable communication link under difficult reception conditions resulting from severe multipath propagation.

It is another object to provide a cost-effective arrangement that enables stable and reliable wireless communication in industrial environments.

It is yet another object to provide a transceiver arrangement including an antenna for establishing a reliable communication link between devices used in automation technology.

According to one aspect of the invention, in an installation comprising sensors, actuators and at least one shared control unit for automatically controlling machine operations, an arrangement for wirelessly connecting at least one of said sensors and actuators to the at least one shared control unit, there is provided an arrangement comprising an RF transmitter and an antenna, a first connection point for receiving an RF transmit signal from the RF transmitter and for providing an RF receive signal from the antenna, a second connection point connecting to the antenna, a signal coupler arranged between the first connection point and the second connection point, said signal coupler being designed to transmit the RF transmit signal from the first connection point to the antenna using a first attenuation factor, and to transmit the RF receive signal from the antenna to the first connection point using a second attenuation factor, the first attenuation factor being smaller than the second attenuation factor, at least one component having a variably adjustable impedance, a control circuit for generating a first control signal designed to set the impedance of the at least one component in order to switch between the first attenuation factor and the second attenuation factor, and a rectifier circuit for converting an AC voltage into a buffered DC voltage, wherein the signal coupler has a first coupler port, a second coupler port, and at least one third coupler port, the first coupler port being connected to the first connection point, the second coupler port being connected to the second connection point, and the at least one third coupler port being connected to the rectifier circuit for generating an operating voltage for the control circuit using the RF transmit signal.

According to another aspect, there is provided an arrangement for wirelessly networking devices in automation technology, comprising a first connection point for receiving an RF transmit signal from an RF transmitter and for providing an RF receive signal from an antenna, comprising a second connection point, which leads to the antenna, and comprising a signal coupler arranged between the first connection point and the second connection point in order to transmit the RF transmit signal from the first connection point to the antenna and in order to transmit the RF receive signal from the antenna to the first connection point, wherein the signal coupler has a variable coupling attenuation having a first attenuation factor and at least one second attenuation factor, with the first attenuation factor being smaller than the second attenuation factor, and wherein the signal coupler transmits the RF receive signal using the first attenuation factor and transmits the RF transmit signal using the second attenuation factor

The new arrangements have a signal coupler designed to be arranged between the antenna and the transmitter/receiver of a communications node. The signal coupler transmits both the outgoing transmit signal and the incoming receive signal. It attenuates the transmit signal, which is transmitted by the RF transmitter to the antenna, more strongly, however, than an incoming receive signal, which is transmitted in the opposite direction from the antenna to the receiver. The signal coupler preferably has a coupling attenuation that switches automatically between the smaller, first attenuation factor and the larger, second attenuation factor as a function of the signal power currently applied to the signal coupler, i.e. according to the RF power transmitted via the signal coupler. The RF transmit signal and the RF receive signal are therefore affected differently by the signal coupler, wherein the coupling attenuation of the signal coupler is variably adjustable. In the preferred case, a high signal power automatically results in the signal coupler adopting the larger, second attenuation factor, whereas a low signal power automatically results in the smaller, first attenuation factor. The arrangement enables the use of a common antenna both for transmitting RF transmit signals and for receiving RF receive signals, which is advantageous for space and cost reasons. A disadvantage with a common transmit and receive antenna, however, is that any optimization of the antenna for the transmit case has an equivalent effect on the receive case, and vice versa.

The RF receive signal at an antenna, because of the distance already traveled from the remote transmitter, is typically several orders of magnitude weaker than an RF transmit signal that is radiated by the same antenna. In order to enable stable reception it is generally desirable to minimize any further attenuation of the otherwise weak RF receive signal. On the other hand, attenuation of the RF transmit signal is acceptable because the transmit power at the antenna tends to be high.

The new arrangements make use of this asymmetry and enable structural designs of the antenna that are well suited for suppressing multipath reflections. In particular, the embodiments of the new arrangement enable the use of a directional antenna instead of the omnidirectional rod antennas normally used until now in this field.

A directional antenna does not radiate an RF transmit signal equally in all directions. Instead, it has one or more preferred directions (known as “radiation lobes”) into which most of the RF transmit power is concentrated. Relatively little RF transmit power is radiated into spatial areas lying outside the radiation lobes. The radiation directions outside the radiation lobes can often be ignored completely in the far field of the antenna. Conversely, a directional antenna receives RF receive signals via the radiation lobes far more strongly than outside the radiation lobes. This directional effect of directional antennas can be advantageously used in the wireless transmission of communications signals in areas that have problematic multipath propagation by aligning the transmit and/or receive antennas of the two communications nodes so that their main lobes face one another. In addition, directional antennas can be used to “blank out” to a certain extent some dihedral angles from which the multipath propagation is particularly troublesome. Therefore, directional antennas can be used very advantageously for optimizing a wireless communications link.

However, a directional antenna cannot simply be used on a conventional transmitter for wireless networking of automation technology devices without the transmitter exceeding the legal limits for the maximum radiated power in the main radiation direction of the antenna, because the conventional transmitters usually have a transmit power that lies just within the permitted limits when using an omnidirectional antenna. Although the directional antenna does not increase the transmit power of the transmitter itself, the total available transmit power is concentrated in the main radiation direction and hence exceeds the legal limits in the main radiation direction. Therefore, if it was wanted to use a directional antenna instead of the typically employed omnidirectional antenna to optimize the communications links in a factory hall, it would be necessary to insert an additional attenuator externally in the signal path between the antenna and the transmitter output stage in order to comply with legal limits. Such an attenuator, however, also attenuates the receive signals, which are very weak anyway, and therefore the advantage that would be possible using a directional antenna per se would be practically cancelled out by the inserted attenuator.

In principle, it would be possible to use separate transmit and receive antennas on the communications nodes, allowing an attenuator to be arranged only in the transmit path. This solution is complicated, space-intensive and expensive, however, because it requires for each communications node concerned separate transmit and receive antennas, and suitably adapted transceivers having separate transmit and receive signal paths. This rules out the low-cost use of transceivers employed in a similar form for commercial WLAN links in home and office areas. In addition, four antennas (2× transmitters, 2× receivers) would be necessary for antenna diversity, which would create space problems.

The new arrangements now enable the use of a single directional antenna having an antenna gain greater than zero compared to a conventional rod antenna, without canceling out the advantage achievable by the antenna gain, as would be the case when a direction-independent attenuator were used. The signal coupler of the new arrangements transmit the high-power RF transmit signal to the antenna using a relatively high attenuation factor. It can thereby attenuate to the permitted limits the RF transmit power radiated by the directional antenna in the main lobe. On the other hand, the same signal coupler transmits an RF receive signal coming from the antenna using a low attenuation factor, so that the receiver benefits from the overall higher signal strength resulting from the antenna gain. Advantageously, the first attenuation factor is significantly less than the antenna gain of the directional antenna used. In addition, a directional antenna can be used to selectively blank out dihedral angles from which strong multipath reflections originate.

As explained below with reference to a preferred exemplary embodiment, the new arrangement can be placed very advantageously in the signal path between the antenna and the antenna connector of the communications node. This makes it possible to use the new arrangement with a conventional transceiver that is actually designed, as regards its radiated transmit power, for use with a rod antenna. Hence the new arrangement enables the advantageous use of a common directional antenna for the transmit and receive case together with a conventional transceiver, while being able to guarantee the legal requirements with regard to the maximum radiated transmit power in all spatial directions, without canceling out the advantage of the directional antenna in the receive case. The new arrangement is therefore an advantageous addition to, or even a substitute for, other measures that are used to implement a stable, wireless communications link in environments having severe multipath propagations.

Furthermore, the variable coupling attenuation can be implemented very easily and at low cost using a signal coupler in the signal path between the two connection points, as shown below with reference to a preferred exemplary embodiment. In a particularly preferred exemplary embodiment, the new arrangement including the signal coupler can be integrated in the mechanical structure of the antenna, so that the user needs simply to connect “a new directional antenna” that includes the new arrangement to an existing transceiver in order to enjoy the benefits. The new arrangement can therefore be advantageously used in existing wireless communications networks in order to improve the availability and stability of the wireless communication.

In a preferred refinement, the antenna has a defined antenna gain, wherein the second attenuation factor is approximately equal to the defined antenna gain.

The antenna gain is generally the ratio of the radiant intensity (and equally the receive intensity) of a directional antenna in the main radiation direction with respect to the radiant/receive intensity of a non-directional omnidirectional antenna. The antenna gain is often defined relative to an ideal isotropic radiator, i.e. relative to an antenna that radiates equally in all spatial directions (in elevation and azimuth). Such an isotropic radiator, however, is an ideal model that actually does not exist. Rod antennas and what are known as dipole antennas come closest to the isotropic radiator. Compared to an ideal isotropic radiator, however, these antennas already have an antenna gain. In the case of the present refinement, the second attenuation factor is approximately equal to the antenna gain that can be achieved by using a directional antenna instead of a rod antenna or dipole antenna. Hence the antenna of this refinement has a defined antenna gain greater than zero relative to a rod antenna. The refinement has the advantage that the increased transmit power in the radiation direction is largely equalized by the second attenuation factor of the signal coupler. The refinement helps to ensure compliance with legal regulations with regard to the maximum radiated transmit powers for all dihedral angles while also not reducing it more strongly than necessary.

In a preferred variant of this refinement, the directional antenna comprises the new arrangement, i.e. the directional antenna and the arrangement are a structural unit which simply needs to be connected to a transceiver via an antenna cable and/or an antenna socket. In this case, the antenna gain of the directional antenna is known, and the second attenuation factor equals the magnitude of the known antenna gain of the antenna relative to a rod antenna.

In another variant, the new arrangement can be implemented separately from the directional antenna used. In these cases it is advantageous if the signal coupler has a plurality of second attenuation factors, which can be selected and adjusted in defined steps or continuously. The new arrangement can thereby be adapted to different directional antennas having individual antenna gains.

In a further refinement, the signal coupler has a first coupler port, a second coupler port and at least one third coupler port, wherein the first coupler port is connected to the first connection point, wherein the second coupler port is connected to the second connection point, and wherein the third coupler port is connected to a component having an impedance that is variably adjustable, wherein the coupling attenuation of the signal coupler depends on the impedance of the component.

In preferred exemplary embodiments of this refinement, the component is a varactor diode having a junction capacitance that can be varied by means of an externally supplied control voltage. In principle, however, the component can also be implemented in a different manner, for example as an electrical circuit containing one or more active components.

The refinement enables a very simple, low-cost and above all low-power adjustment of the attenuation factor of the new arrangement. The capacitance (and hence the impedance) of a varactor diode can be varied using a low control voltage. The impedance of the component can advantageously be changed over more than two levels, enabling a multilevel adjustment of the coupling attenuation. Signal couplers having at least three coupler ports can be implemented very easily and economically in radio frequency circuits.

In a further refinement, the component has an impedance base value that is selected such that the signal coupler has the first attenuation factor as a default factor.

In this refinement, when there is no control voltage at the component, the signal coupler has the smaller, first attenuation factor, which is preferably as low as possible. The signal coupler is therefore designed in the default case for receiving an RF receive signal. Only when an RF transmit signal is to be radiated, the attenuation factor is changed by adjusting the impedance of the component to a defined impedance value that differs from the impedance base value. The coupling factor of the signal coupler is changed by setting a different impedance value. Consequently the conditions under which a signal is transmitted from one coupler port to the other coupler ports vary. The impedance change of the component therefore changes the signal distribution within the signal coupler and hence the attenuation factor with which a supplied RF transmit signal or RF receive signal is transmitted between the external connection points. The preferred refinement has the advantage that the low, first attenuation factor always exists automatically when the component is not receiving any control signal. Thus the attenuation factor required for the receive case can be set using no power. A control signal is only needed for the transmit case. In the transmit case, however, at least the RF transmit power is available, which in some exemplary embodiments is advantageously used to generate the control signal.

In a further refinement, the arrangement has a first control circuit for generating a first control signal, which is designed to set the impedance of the component such that the signal coupler has the second attenuation factor.

In this refinement, the control circuit for generating the control signal for the component is part of the arrangement. Alternatively or additionally, such a control circuit could be implemented separately from the arrangement in order to control the changeover from the first attenuation factor to the second attenuation factor from outside. Integrating the control circuit into the arrangement has the advantage that the arrangement can be operated autonomously. In particular, this refinement makes it easier to integrate the new arrangement in an antenna, enabling extremely simple and rugged assembly.

In a further refinement, the control circuit generates the first control signal automatically whenever the signal coupler is transmitting the RF transmit signal.

The control circuit can detect the RF transmit signal for example from the signal strength at a defined measuring point. In a preferred exemplary embodiment, the control circuit comprises an envelope and threshold detector, which diverts from the RF transmit signal an envelope signal having a lower signal frequency than the high frequency of the RF transmit signal. This envelope signal signals by a pulse when the RF transmit signal is applied to the signal coupler. Using the envelope signal, the impedance of the component is advantageously changed in order to set the second attenuation factor. The refinement ensures that the RF transmit signal is transmitted automatically using the larger, second attenuation factor. Thus the refinement helps to ensure compliance with legal limits for the maximum permitted radiation power of a wireless communications link.

In a further refinement, the RF transmit signal has a variable transmit power, wherein the control circuit is designed to generate the control signal approximately in proportion to the variable signal power.

In this refinement, the control signal is again preferably derived from the RF transmit signal itself. In preferred exemplary embodiments, the control circuit has temperature compensation which helps to maintain the proportional dependency of the control signal on the RF transmit signal power. The proportional dependency preferably exists for the majority of the working range in which the transmit signal power of the RF transmit signal can vary. In an exemplary embodiment, an average value of the envelope signal is determined, and this average value forms the control signal. The refinement enables an advantageous regulation of the attenuation factor by individual adjustments to changing operating conditions. It also enables optimum adjustment of the attenuation factor to the RF transmit signal power fed into the first connection point. Thus this refinement helps to operate the new arrangement with the maximum permitted transmit signal power at any one time.

In a further refinement, the third coupler port is connected to a rectifier circuit, which converts an AC voltage applied to the third coupler port into a buffered DC voltage.

In this refinement, the “excess transmit signal power”, which is kept away from the antenna by means of the second attenuation factor, is used to generate a buffered DC voltage. The buffered DC voltage is advantageously used as an operating voltage for the active components of the new arrangement. The refinement uses a characteristic property in wireless communication of devices in automation technology, namely the generally cyclical recurrence of transmit pulses. The component-generated mismatch of the signal coupler at the second coupler port results in the excess RF transmit signal power being fed to the third coupler port. Here it is advantageously converted into the buffered DC voltage, which is used as an operating voltage for supplying active components of the arrangement. The refinement enables autonomous operation of the new arrangement without an externally supplied operating voltage. This refinement is particularly advantageous when the new arrangement is structurally integrated in a directional antenna, because the directional antenna containing the integral arrangement merely needs an RF antenna connection despite active components. At the same time, it avoids signal interference that can easily occur if an attempt were made to supply an external operating voltage via the one antenna connection.

In a further refinement, the signal coupler has two third coupler ports, which are combined in-phase at a summation point.

In this refinement, the signal coupler has at least four coupler ports. In the preferred exemplary embodiments, the signal coupler has precisely four coupler ports, of which the first coupler port and the second coupler port are connected to the first connection point and to the second connection point respectively. The “two third” coupler ports are used for diverting the excess RF transmit signal power. The use of two third coupler ports, which are combined in-phase at the summation point, enables a high degree of efficiency, in particular in the advantageous generation of the buffered DC voltage.

In a further refinement, the signal coupler is a branch line coupler, also known as a 90° hybrid coupler. A three-arm branch line coupler is particularly advantageous, in particular when the center arm is thicker than the two outer arms.

Branch line couplers have been shown to have the advantageous property that the impedance at the first coupler port and second coupler port changes only relatively slightly when the impedance of the component at the third coupler port is changed. In other words, there is relatively low feedback of the impedance change at the third coupler port to the first and second coupler ports. Therefore this refinement helps to affect the signal flow between the first connection point and the second connection point only in terms of the desired change in the attenuation factor. There is almost no negative impact on the matching of the signal coupler to the transceiver and the antenna when a branch line coupler is used.

In a further refinement, the arrangement comprises an antenna having a number of first radiator elements, a number of second radiator elements and at least one switching element, wherein the first radiator elements are directly connected to the second connection point, wherein the second radiator elements are connected to the second connection point via the at least one switching element, and wherein the at least one switching element is controlled by a second control signal, which is generated from the RF transmit signal.

In this refinement, the antenna is part of the new arrangement. In preferred exemplary embodiments, the signal coupler and the other circuit elements of the arrangement are structurally integrated in the antenna body. The antenna of this refinement has at least two different radiator elements, of which one is permanently connected to the signal coupler, while the other can be connected to the signal coupler or disconnected from the signal coupler selectively via a switching element. “Directly” in terms of this refinement therefore does not exclude a case in which other components, such as a bandpass filter, may also lie between the second connection point and the first radiator element. These other components, however, are not switching elements used to change the radiating arrangement. In one variant, the at least one second radiator element is connected to the signal coupler whenever an RF transmit signal is radiated via the antenna. In the receive case, the second radiator element is “switched off” via the switching element, i.e. it does not supply any signal contribution to the signal coupler. In another variant, the at least one second radiator element is always connected to the signal coupler if (and only if) an RF receive signal is being received via the antenna. When an RF transmit signal is being radiated, the at least one second radiator element is disconnected from the transmit signal via the switching element.

By switching in or switching out the second radiator element, the directivity of the antenna changes and therefore also the antenna gain. Hence this refinement enables further optimization of the transmit and receive properties in order to cope with communication interference caused by multipath propagation. Switching between different directivities of the antenna is advantageously also performed here automatically in dependence on the RF transmit signal. In this refinement, again, it is particularly advantageous if the operating voltage needed to generate the second control signal is generated from the RF transmit signal, as has already been mentioned above. In addition to the direction-dependent attenuation of the RF signals, the directivity of the antenna, and hence the antenna gain, is now also changed. In a preferred variant, the antenna of the new arrangement radiates in the transmit case using a lower antenna gain in a wider spatial area, whereas in the receive case it works using a higher antenna gain and consequently picks up only signals from a narrower dihedral-angle range. This variant can be implemented easily by switching in the second radiator elements in the transmit case. In principle, however, the opposite variant is also possible, i.e. the antenna is operated in the receive case using a lower antenna gain, and in the transmit case using a higher antenna gain (narrower directivity). In a particularly preferred exemplary embodiment, the directivity is primarily changed in elevation. Alternatively or additionally, it is possible to automatically switch over directivity in the azimuth to suit the transmit case or receive case. In preferred exemplary embodiments, the radiator elements are patch radiator elements, which radiate and receive with a circular polarization. In other exemplary embodiments, the radiator elements can have a predominantly horizontal polarization or a predominantly vertical polarization.

It goes without saying that the aforementioned features and the features yet to be described below can be used not just in each particular combination specified but also in other combinations or in isolation, without going beyond the present invention.

### BRIEF DESCRIPTION OF THE DRAWINGS

Exemplary embodiments of the invention are shown in the drawing and are explained in greater detail in the following description. In the drawing:

FIG. 1 shows a simplified diagram of a control system for automated control of a technical installation, wherein a control unit is networked wirelessly to sensors and actuators and wherein the new arrangement is used in order to cope with multipath propagation;

FIG. 2 shows a schematic diagram of a preferred exemplary embodiment of the new arrangement; and

FIG. 3 shows a preferred exemplary embodiment of a signal coupler having a variable coupling attenuation for the arrangement of FIG. 2.

### DESCRIPTION OF PREFERRED EMBODIMENTS

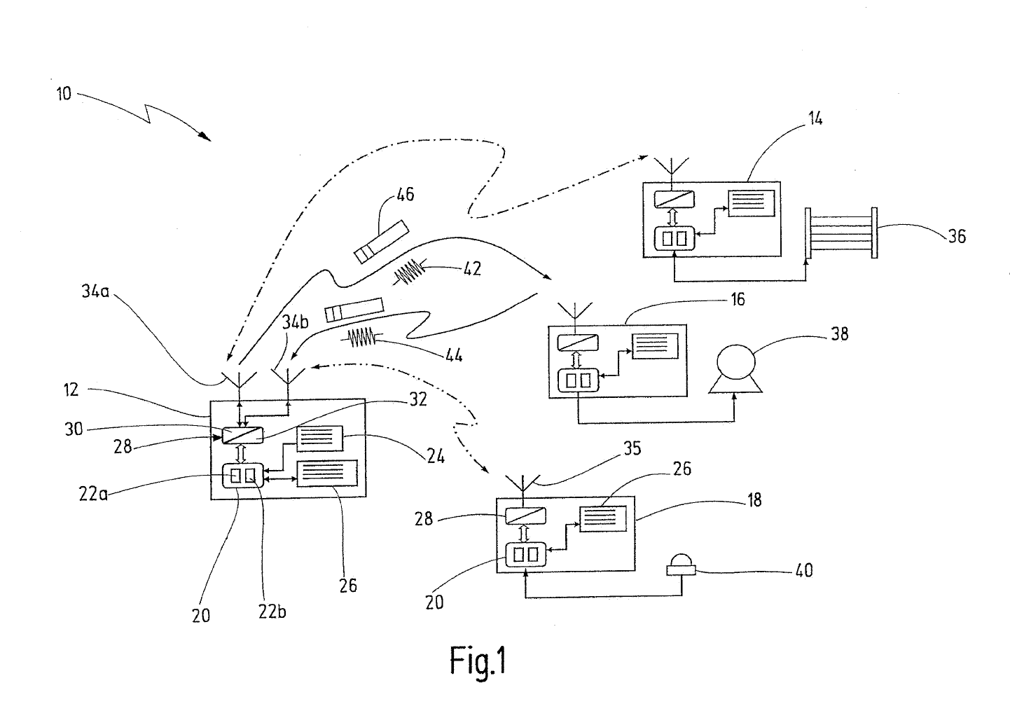

In FIG. 1, a control system for automated control of a technical installation is denoted overall by reference number 10. The control system 10 has a control unit 12, for example in the form of a programmable logic controller, and a number of signal units 14, 16, 18. The signal units 14, 16, 18 are arranged spatially apart from the control unit 12 and communicate wirelessly via radio signals with the control unit 12. The control unit 12 can also be connected to other signal units (not shown here) via network lines. In addition, the control system 10 can comprise a plurality of control units 12, which are arranged in a distributed manner and communicate amongst one another wirelessly and/or with one another via network cables. In a preferred exemplary embodiment, the control system 10 is used to control a crane installation, which is arranged in a factory hall. In other exemplary embodiments, the control system controls a production line comprising robots, machine tools, conveyor belts, packaging machines and other equipment. The new arrangement can generally be used in all technical installations in which control units and/or signal units communicate wirelessly with one another. The new arrangement is preferably used in control units and/or signal units that communicate with one another primarily or exclusively cyclically in fixed time intervals. Typically, the control units and/or signal units transfer only a few data messages in each communications cycle. In some cases, the control unit sends exactly one data message to each signal unit in each cycle, and it receives exactly one data message from each signal unit in each case.

The control unit 12 has a signal and data processing section 20, which in the preferred exemplary embodiments is designed with multichannel redundancy. In FIG. 1, two processors 22a, 22b are used by way of example to show the redundant channels. Preferably, at least part of the signal and data processing is performed redundantly, wherein the processors 22a, 22b compare their respective results with one another and/or monitor one another in order to guarantee failsafe signal and data processing as defined by standards EN 954-1, IEC 61508 and/or EN ISO 13849-1. In the preferred exemplary embodiments, the control unit 12 is designed to be failsafe as defined by category 3 and above of EN 954-1 or as defined by comparable requirements, for instance SIL 2 of IEC 61508.

The control unit 20 also comprises memories 24, 26, wherein the memory 24 is shown here as a read-only memory, whereas the memory 26 is a read/write memory. An operating system of the control unit 12 is here stored in the memory 24. The control unit 12 uses memory 26 for temporary storage of data during the signal and data processing. A control program, on the basis of which the control unit 12 processes data from the signal units 14, 16, 18, can be stored in one of the memories 24, 26 or in both memories.

Reference number 28 denotes a transmit and receive section. The transmit and receive section 28 comprises an RF transmitter 30 and an RF receiver 32. Transmitter 30 and receiver 32 are designed respectively to transmit and receive RF signals via one or more antennas 34. In the preferred exemplary embodiments, the frequency of the RF signals lies at about 2.4 GHz and/or at about 5 GHz. In principle, however, other frequency bands are also possible.

The control unit 12 comprises, in the exemplary embodiment shown here, two antennas 34a, 34b, which are used alternatively to one another both as a transmit antenna and as a receive antenna. A preferred antenna design for the antennas 34a, 34b is described in US 2011/043432 A1, which is incorporated by reference herewith.

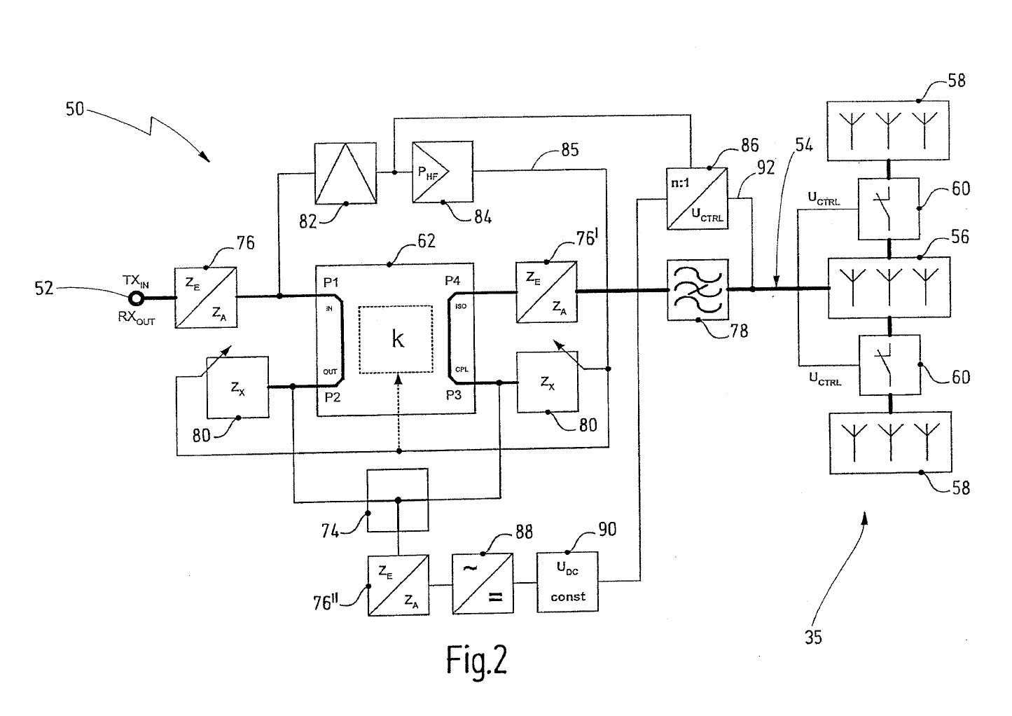

The signal units 14, 16, 18 have a similar design to the control unit 12. The same reference signs denote same components. In the preferred exemplary embodiments, the signal units 14, 16, 18 also comprise a signal and data processing section 20 having multichannel redundancy, so that the signal units 14, 16, 18 are failsafe as defined by the aforementioned standards. Each signal unit 14, 16, 18 comprises a transmit and receive section 28 and an antenna 35. In the exemplary embodiment shown, the antenna 35 is part of the new arrangement, as explained below with reference to FIG. 2. In other words, the new arrangement is here structurally integrated in the body of the antenna 35, and it is simply connected to the transmit and receive section 28 via a conventional antenna cable (typically a coaxial cable).

By way of example, signal unit 14 is here connected to a light curtain 36. It controls the light curtain 36 and reports the status of the light curtain 36 (unobstructed or obstructed) to control unit 12. Signal unit 16 is connected to an electrical drive 38 and controls the drive 38 on the basis of actuator data that the signal unit 16 receives from the control unit 12. The signal unit 18 is connected by way of example to an emergency stop pushbutton 40 and reports the status of the emergency stop pushbutton 40 (actuated or not actuated) to the control unit 12. The control unit 12 determines the actuator data for the signal unit 16 on the basis of the sensor data from the signal units 14, 18. Obviously, the control system 10 can comprise other sensors and actuators that are networked to the control unit 12, in addition to the signal units 14, 16, 18 shown here and the sensors 36, 40 and actuators 38. It is possible in particular, that one signal unit monitors and/or controls a plurality of sensors and/or actuators.

The control unit 12 communicates with the signal units 14, 16, 18 by means of radio signals 42, 44. FIG. 1 shows an RF transmit signal 42, which the control unit 12 transmits via one of the antennas 34a, 34b. In the diagram, the signal unit 16 receives the RF transmit signal 42 from the control unit, and it generates an RF signal 44, which the control unit 12 receives as an RF receive signal. Obviously, each RF transmit signal 42 is an RF receive signal 44 for all the other communications nodes.

The RF signals 42, 44 each carry one or more data messages 46, which include the sensor data and actuator data. In the RF receiver 32, the data messages 46 are extracted from the RF receive signals 44 and supplied to the signal and data processing section 20. In the opposite direction, the RF transmitter 30 modulates an RF transmit signal 42 such that the data message 46 is included in the RF signal. In the preferred exemplary embodiments, communication between the control unit 12 and the signal units 14, 16, 18 takes place cyclically in regularly defined time intervals, wherein the control unit 12 addresses the signal units 14, 16, 18 in sequence and waits for a response in each case. Each signal unit 14, 16, 18 identifies from an address included in the data messages 46 whether or not it is being addressed.

In FIG. 2, a preferred exemplary embodiment of the new arrangement is denoted overall by reference number 50. The arrangement 50 comprises a first connection point 52 and a second connection point 54. In the preferred exemplary embodiment, the arrangement 50 is structurally integrated in the antenna body, i.e. the arrangement 50 includes the antenna 35. Therefore in the present case, the second connection point 54 is not a “visible” connection point in the form of a connector or socket. In contrast, the first connection point 52 is here an antenna socket, to which an antenna cable can be connected. The connection point 52 connects the arrangement 50 both to an RF transmitter and to an RF receiver. Any signal isolation that may be required between RF transmit signal and RF receive signal takes place in the transmit and receive section 28 in the preferred exemplary embodiments.

In the exemplary embodiment shown here, the antenna 35 comprises a number of first radiator elements 56 and second radiator elements 58. The first radiator elements 54 are permanently connected to the connection point 54. The second radiator elements 58 are connected to the connection point 54 via a switching element 60 and can be isolated from the connection point 54 via the switching element 60. In a preferred exemplary embodiment, the first radiator elements and second radiator elements 56, 58 are each substantially square patch elements in a planar array of radiator elements in rows and columns. Each radiator element 56, 58 comprises two terminals spatially offset from one another by 90° in order to enable the radiation and reception of circularly polarized waves. In the preferred exemplary embodiment, the first radiator elements 56 are arranged in a central row between two rows of second radiator elements 58. If the second radiator elements 58 are connected to the first radiator elements 56 via the switching elements 60, the radiation lobe of the antenna 35 becomes narrower than in the opposite case in which the radiator elements 58 are disconnected from the first radiator elements 56 via the switching elements 60. The switching elements 60 therefore make it possible to change the radiation lobe of the antenna 35 (and hence the antenna gain). In the currently preferred exemplary embodiment, one group of second radiator elements 58 is arranged above a group of first radiator elements 56, and one group of second radiator elements 58 is arranged below, so that the radiation lobe of the antenna 35 is changed in elevation.

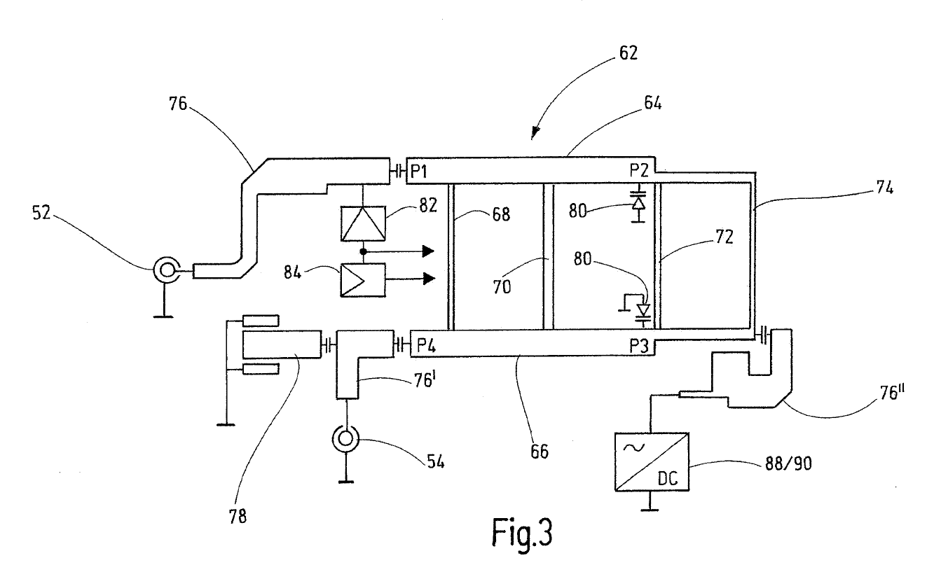

The arrangement 50 also comprises a signal coupler 62. A preferred exemplary embodiment of the signal coupler 62 is shown in FIG. 3. Same reference numbers denote the same elements as in FIG. 2.

The signal coupler 62 has four coupler ports P1, P2, P3 and P4. The coupler ports P1 and P2 are the open ends of a first series arm 64. The coupler ports P4 and P3 are the open ends of a second series arm 66. The two mutually parallel series arms 64, 66 are connected together via three parallel shunt arms 68, 70, 72. The series arms 64, 66 and shunt arms 68, 70, 72 here form a “ladder”. A fourth shunt arm 74 has an approximately U-shaped design and connects the open ends P2 and P3 of the series arms 64, 66. Shunt arm 74 forms a summation arm, via which signals from the coupler ports P2 and P3 are added in-phase.

The first coupler port P1 is connected to the first connection point 52 via an impedance matcher 76. In the preferred exemplary embodiment, the impedance matcher 76 is a suitably shaped microstrip line. The coupler port P4 is connected to the radiator elements 56, 58 via a further impedance matcher 76′ and a bandpass filter 78. The coupler port P1 hence forms the signal input for an RF transmit signal, which is transmitted to the antenna 35 via the coupler port P4. In the opposite direction, the coupler port P4 forms a signal input for an RF receive signal from the antenna 35, which is transmitted to the connection point 52 via the coupler port P1.

At each of the coupler ports P2 and P3 is arranged a component 80 having a variably adjustable impedance. In the preferred exemplary embodiments, the component 80 is a varactor diode, the junction capacitance of which can be changed using a control voltage. The control voltage for the component 80 is here generated using an envelope detector 82 and a regulating-voltage generator 84. The envelope detector 82 generates from an RF signal applied to the coupler port P1 an AC signal, which has a low frequency compared with the RF signal and which corresponds approximately to the envelope of the RF signal at the coupler port P1. The subsequent regulating-voltage generator 84 generates a DC voltage, which equals approximately the mean power of the envelope signal from the envelope detector 82. The output voltage 85 from the regulating-voltage generator 84 is supplied to the components 80 as a first control signal and defines the impedance of the components 80.

In the preferred exemplary embodiments, the components 80 have an impedance base value, which exists when the regulating voltage from the regulating-voltage generator 84 is not supplied. This impedance base value can be changed by the regulating voltage 85. The impedance base value of the components 80 is preferably selected so that the coupler ports P2 and P3 in the “de-energized” state, i.e. without the regulating voltage 85, have a maximum mismatch with respect to the coupler ports P2 and P3. The result of the mismatch is that a signal applied to the coupler port P1 is mostly transmitted to the coupler port P4 and scarcely appears or does not appear at all at the coupler ports P2 and P3. The coupling attenuation from the coupler port P1 to the coupler ports P2 and P3 respectively is at a maximum without the regulating voltage 85. Hence the coupling attenuation between the coupler port P1 and the coupler port P4 is at a minimum in this case.

The regulating-voltage generator 84 and the components 80 are designed here so that the coupling attenuation between the coupler ports P1 and P4 rises with increasing RF signal power, whereas the coupling attenuation between the coupler port P1 and the coupler ports P2 and P3 respectively decreases. Consequently, as the RF signal power increases at the coupler port P1, an increasingly larger proportion of the RF signal is transmitted from port P1 to the coupler ports P2 and P3.

In the transmit case, the RF power of the RF transmit signal at the coupler port P1 is relatively large. Therefore, the impedance of the components 80 is changed by means of the regulating-voltage generator 84. The coupler ports P2 and P3 are now better matched to the coupler port P1 and extract RF power from the signal reaching coupler port P4. The RF transmit signal arriving at the coupler port P4 is consequently weaker than the RF transmit signal fed in at the coupler port P1. Hence a weaker RF transmit signal is radiated via antenna 35. In the ideal case, the amount of transmit signal power extracted from the RF transmit signal radiated via the antenna 35 equals exactly the amount by which the antenna 35 increases the RF transmit signal in the main radiation direction compared with an alternative rod antenna. This means that compliance with legal regulations in respect of maximum permitted transmit signal powers is also maintained when a rod antenna used so far is replaced by the arrangement 50 that includes the directional antenna 35.

In the receive case, the RF signal power arriving at the coupler port P1 is very low. Hence the regulating-voltage generator 84 generates a negligible regulating voltage 85. The components 80 therefore have an impedance value that is approximately equal to the impedance base value. Owing to the deliberate mismatch of the impedance base value at the coupler ports P2 and P3, the coupling attenuation between the coupler ports P4 and P1 is at a minimum then.

The RF transmit signal power diverted in the transmit case is combined in-phase at the summation point 74 and fed via a further impedance matcher 76″ to an RF rectifier 88. The RF rectifier 88 generates a pulsed DC voltage, which is converted into a buffered DC voltage U_{DC} by a switching regulator. The buffered DC voltage U_{DC} is advantageously used as an operating voltage for the active components of the arrangement 50.

In the preferred exemplary embodiments, an active component of this type is a control-signal circuit 86, which generates the control signal for the switching elements 60. The control-signal circuit 86 comprises a number of D-type flip-flops (not shown here), which form a divider chain. The divider chain generates from the pulsed envelope signal from the envelope detector 82 a control voltage 92, which is used to switch over the switching elements 60 of the antenna 35. In an exemplary embodiment, the switching elements 60 are likewise varactor diodes, which in this case, unlike the varactor diodes 80, are operated in the “on-off state”. Since communication between the control unit 12 and the signal units 14, 16, 18 in the preferred exemplary embodiments takes place in defined cyclical time intervals, the switching elements 60 are switched over in the defined cyclical time intervals. In one exemplary embodiment, the switching elements 60 are switched over after each transmit burst that is transmitted from the RF transmitter 30 via the arrangement 50. In another exemplary embodiment, the switching elements 60 are switched over after every fourth transmit burst from the RF transmitter 30. Other switching rhythms are also possible.

In the preferred exemplary embodiments, the switching signal from the control-signal circuit 86 is a DC voltage signal, which is transmitted as the control signal 92 to the switching elements 60 via the same line over which the RF transmit signal also reaches the radiator elements 56, 58. The control signal 92 is superimposed on the RF transmit signal.

Although the radiator elements 56, 58 are integrated in the arrangement 50 in the preferred exemplary embodiment shown, in other exemplary embodiments, the arrangement 50 can be implemented separately from radiator elements and an antenna composed thereof. In this case, the second connection point 54 is advantageously implemented as a socket for connecting an antenna cable.

In further exemplary embodiments, the arrangement 50 can be integrated in the transmit and receive section 28 of a communications node. In these cases, the first connection point may be a “hidden” signal point within an integrated circuit, if applicable.

The antenna 35 can be implemented differently from the variant shown here. For instance, it can be composed of individual horizontal and vertical dipoles, with switching elements 60 being used to selectively switch between said dipoles. Furthermore, it is possible in further exemplary embodiments to dispense with the antenna switchover and merely use the variable coupling attenuation of the signal coupler 62 on the basis of the (transmit) signal power at the first coupler port P1. In principle, an operating voltage for supplying active components of the arrangement 50 can also be provided externally, so that the RF rectifier 88 and the switching regulator 90 can be dispensed with.

It is advantageous for all exemplary embodiments that a signal coupler having at least three coupler ports is used, wherein a switching element arranged at the third coupler port is changed such that the coupling attenuation between the first coupler port and the second coupler port varies. By means of the variation of the coupling attenuation, part of the RF transmit signal power is extracted from an RF transmit signal, whereas an RF receive signal is transmitted largely unaffected. The coupling attenuation is advantageously varied by causing or avoiding a deliberate mismatch at the third coupler port.

What is claimed is:

1. In an installation comprising sensors, actuators and at least one shared control unit for automatically controlling machine operations, an arrangement for wirelessly connecting at least one of said sensors and actuators to the at least one shared control unit, the arrangement comprising:
an RF transmitter and an antenna,
a first connection point for receiving an RF transmit signal from the RF transmitter and for providing an RF receive signal from the antenna,
a second connection point connecting to the antenna,
a signal coupler arranged between the first connection point and the second connection point, said signal coupler being designed to transmit the RF transmit signal from the first connection point to the antenna using a first attenuation factor, and to transmit the RF receive signal from the antenna to the first connection point using a second attenuation factor, the first attenuation factor being smaller than the second attenuation factor,
at least one component having a variably adjustable impedance,
a control circuit for generating a first control signal designed to set the impedance of the at least one component in order to switch between the first attenuation factor and the second attenuation factor, and
a rectifier circuit for converting an AC voltage into a buffered DC voltage,
wherein the signal coupler has a first coupler port, a second coupler port, and at least one third coupler port, the first coupler port being connected to the first connection point, the second coupler port being connected to the second connection point, and the at least one third coupler port being connected to the rectifier circuit for generating an operating voltage for the control circuit using the RF transmit signal.

2. The arrangement of claim 1, wherein the antenna has a defined antenna gain, and wherein the second attenuation factor is substantially equal to the defined antenna gain.

3. The arrangement of claim 1, wherein the component has an impedance base value that is selected such that the signal coupler adopts the first attenuation factor when the first control signal is zero.

4. The arrangement of claim 1, wherein the control circuit automatically generates the first control signal whenever the signal coupler is transmitting the RF transmit signal.

5. The arrangement of claim 1, wherein the RF transmit signal has a variable transmit signal power, and wherein the control circuit is designed to generate the first control signal substantially proportional to the variable transmit signal power.

6. The arrangement of claim 1, wherein the signal coupler is a branch line coupler.

7. The arrangement of claim 1, wherein the antenna has a number of first radiator elements, a number of second radiator elements and at least one switching element, wherein the first radiator elements are directly connected to the second connection point, and wherein the second radiator elements are connected to the second connection point via the at least one switching element, with the at least one switching element being configured to disconnect the second radiator elements from the second connection point in response to a second control signal from the control circuit.

8. The arrangement of claim 7, wherein the control circuit is designed to generate the second control signal in response to the RF transmit signal.

9. The arrangement of claim 1, wherein the at least one third coupler port comprises two third coupler ports which are combined in-phase at a summation point, with said rectifier circuit being coupled to the summation point.

10. An arrangement for wirelessly networking devices in automation technology, comprising a first connection point for receiving an RF transmit signal from an RF transmitter and for providing an RF receive signal from an antenna, comprising a second connection point, which leads to the antenna, and comprising a signal coupler arranged between the first connection point and the second connection point in order to transmit the RF transmit signal from the first connection point to the antenna and in order to transmit the RF receive signal from the antenna to the first connection point, wherein the signal coupler has a variable coupling attenuation having a first attenuation factor and at least one second attenuation factor, with the first attenuation factor being smaller than the second attenuation factor, and wherein the signal coupler transmits the RF receive signal using the first attenuation factor and transmits the RF transmit signal using the second attenuation factor.

11. The arrangement of claim 10, wherein the antenna has a defined antenna gain, and wherein the second attenuation factor is approximately equal to the defined antenna gain.

12. The arrangement of claim 10, further comprising a component having an impedance that is variably adjustable, wherein the signal coupler has a first coupler port, a second coupler port and at least one third coupler port, with the first coupler port being connected to the first connection point, with the second coupler port being connected to the component, and wherein the coupling attenuation of the signal coupler depends on the impedance of said component.

13. The arrangement of claim 12, wherein the component has an impedance base value that is selected such that the signal coupler adopts the first attenuation factor as a default attenuation factor.

14. The arrangement of claim 12, further comprising a control circuit for generating a first control signal designed to set the impedance of said component such that the signal coupler adopts the second attenuation factor.

15. The arrangement of claim 14, wherein the control circuit automatically generates the first control signal whenever the signal coupler is transmitting the RF transmit signal.

16. The arrangement of claim 14, wherein the RF transmit signal has a variable transmit signal power, and wherein the control circuit is designed to generate the control signal substantially proportionally with respect to the variable transmit signal power.

17. The arrangement of claim 12, wherein the third coupler port is connected to a rectifier circuit configured to convert an AC voltage applied to the third coupler port into a buffered DC voltage.

18. The arrangement of claim 12, wherein the at least one third coupler port comprises two third coupler ports which are combined in-phase at a summation point.

19. The arrangement of claim 1, wherein the signal coupler is a three-arm branch line coupler.

20. The arrangement of claim 1, further comprising the antenna and at least one switching element, wherein the antenna has a number of first radiator elements and a number of second radiator elements, wherein the first radiator elements are directly connected to the second connection point, wherein the second radiator elements are connected to the second connection point via the at least one switching element, and wherein the at least one switching element is configured to disconnect the second radiator elements from the second connection point in response to a second control signal, which is generated from the RF transmit signal.
